(19) United States
(12) Patent Application Publication
(10) Pub. No.: US 2010/0010856 A1
(43) Pub. Date: Jan. 14, 2010

(54) METHOD AND SYSTEM FOR CONSTRAINT-BASED PROJECT SCHEDULING

(76) Inventors: Kim Huat David Chua, Singapore (SG); Lijun Shen, Singapore (SG); Kim Hoong Lee, Singapore (SG)

Correspondence Address: MICHAEL W. TAYLOR, P.O. BOX 3791, ORLANDO, FL, 32802-3791, US

(21) Appl. No.: 12/278,610

(22) PCT Filed: Feb. 8, 2007
(86) PCT No.: PCT/SG07/00043

§ 371 Date: Dec. 10, 2008

Related U.S. Application Data
(60) Provisional application No. 60/771,565, filed on Feb. 8, 2006.

(51) Int. Cl. G06Q 10/00

(52) U.S. Cl. 705/8

(57) ABSTRACT

A method and system of constraint-based project scheduling. The method comprises maintaining a first database containing project scheduling data associated with at least a current period and a next period of an assignment plan; maintaining a second database containing data associated with a look ahead plan, the look ahead plan covering at least an overlap portion of the next period of the assignment plan such that the look ahead plan overlaps the assignment plan; transferring data associated with one or more shielded tasks having a starting time within the overlap portion of the next period from the second database into the first database as a modification of the project scheduling data associated with the next period of the assignment plan; and executing the project according to the next period of the assignment plan based on the modified project scheduling data associated with the next period in the first database.

### FIELD OF INVENTION

This invention relates to a method and system for constraint-based project scheduling and to a data storage medium containing computer readable code means for instructing a computer system to execute a method for constraint-based project scheduling.

### BACKGROUND

Project planning typically involves at least five stages, namely, strategic, master, phase, look-ahead, and commitment. The focus and method for each stage are different. At present, critical path method (CPM) based project management tools have been widely used in high-level planning (i.e., master and phase). However, these CPM tools are generally unsuitable for low-level planning (i.e., look-ahead and commitment) because these tools ignore many indispensable prerequisite constraints (e.g., resource and information availabilities, contract, and safety), which are trivial at high-level planning but important at low-level planning. Changing the scope of planning leads to a substantial reform of mindset and methodology in terms of shifting the management focus from big activities to smaller tasks and constraints. At low-level planning stage, activities need to be broken down into manageable-sized tasks and the impact of non-precedence constraints should be accounted for in order to make realistic schedules. The basic CPM approach works well in high-level planning but may be ineffective in the scope of low-level planning.

A need therefore exists to provide a method and system for constraint-based project scheduling that addresses at least one of the above-mentioned problems.

### SUMMARY

In accordance with a first aspect of the present invention, there is provided a method of constraint-based project scheduling comprising maintaining a first database containing project scheduling data associated with at least a current period and a next period of an assignment plan; maintaining a second database containing data associated with a look ahead plan, the look ahead plan covering at least an overlap portion of the next period of the assignment plan such that the look ahead plan overlaps the assignment plan; transferring data associated with one or more shielded tasks having a starting time within the overlap portion of the next period from the second database into the first database as a modification of the project scheduling data associated with the next period of the assignment plan; and executing the project according to the next period of the assignment plan based on the modified project scheduling data associated with the next period in the first database.

The method may further comprise displaying respective portions of the assignment plan and the look ahead plan based on the data contained in the first and second databases respectively and including the overlap portion of the next period.

The method may further comprise generating an advisory schedule path based on processing the project scheduling data in the second database.

The method may further comprise updating the advisory schedule path based on modifications of project scheduling data in the second database.

The advisory schedule path may be generated based on the Augmented Precedence Diagram Method (APDM) or the Augmented Critical Path Method (ACPM).

The method may further comprise displaying the advisory schedule path on the displayed look ahead plan.

The look ahead plan may comprise a pulling period, and the method further comprises manipulating the project scheduling data associated with the pulling period based on analysis of constraints and the advisory schedule path.

The method may further comprise maintaining a third database containing data associated with the constraints, and updating status information of the constraints as a manipulation of the data in the third database.

The data associated with the constraints may comprise a set of verification parameters for each constraint for tracking and managing a hidden flow associated with the project.

Only data associated with tasks shielded from uncertainties in the constraints associated with said respective tasks may be available for transfer into the first database.

Data associated with tasks having uncertainties in the constraints associated with said respective tasks may not be available for transfer into the first database, and data representing starting dates of said respective tasks in the look ahead plan is manipulated to be outside at least the overlap portion of the next period.

In accordance with a second aspect of the present invention, there is provided a system for constraint-based project scheduling comprising a first database containing project scheduling data associated with at least a current period and a next period of an assignment plan; a second database containing data associated with a look ahead plan, the look ahead plan covering at least an overlap portion of the next period of the assignment plan such that the look ahead plan overlaps the assignment plan; and a processor unit for transferring data associated with one or more shielded tasks having a starting time within the overlap portion of the next period from the second database into the first database as a modification of the project scheduling data associated with the next period of the assignment plan.

The system may further comprise a display for displaying respective portions of the assignment plan and the look ahead plan based on the data contained in the first and second databases respectively and including the overlap portion of the next period.

The processor unit may generate an advisory schedule path based on processing the project scheduling data in the second database.

The processor unit may update the advisory schedule path based on modifications of project scheduling data in the second database.

The advisory schedule path may be generated by the processor unit based on the Augmented Precedence Diagram Method (APDM) or the Augmented Critical Path Method (ACPM).

The display may further display the advisory schedule path on the displayed look ahead plan.

The look ahead plan may comprise a pulling period, and the processor unit is utilised to manipulate the project scheduling data associated with the pulling period based on analysis of constraints and the advisory schedule path.

The system may further comprise a third database containing data associated with the constraints, and the data processor is utilised to update status information of the constraints as a manipulation of the data in the third database.

The data associated with the constraints may comprise a set of verification parameters for each constraint for tracking and managing a hidden flow associated with the project.

One data associated with tasks shielded from uncertainties in the constraints associated with said respective tasks may be available for transfer into the first database.

Data associated with tasks having uncertainties in the constraints associated with said respective tasks may not be available for transfer into the first database, and data representing starting dates of said respective tasks in the look ahead plan is manipulated to be outside at least the overlap portion of the next period.

In accordance with a third aspect of the present invention, there is provided a system of constraint-based project scheduling comprising means for maintaining a first database containing project scheduling data associated with at least a current period and a next period of an assignment plan; means for maintaining a second database containing data associated with a look ahead plan, the look ahead plan covering at least an overlap portion of the next period of the assignment plan such that the look ahead plan overlaps the assignment plan; means for transferring data associated with one or more shielded tasks having a starting time within the overlap portion of the next period from the second database into the first database as a modification of the project scheduling data associated with the next period of the assignment plan.

In accordance with a fourth aspect of the present invention, there is provided a data storage medium containing computer readable code means for instructing a computer system to execute a method for constraint-based project scheduling comprising maintaining a first database containing project scheduling data associated with at least a current period and a next period of an assignment plan; maintaining a second database containing data associated with a look ahead plan, the look ahead plan covering at least an overlap portion of the next period of the assignment plan such that the look ahead plan overlaps the assignment plan; and transferring data associated with one or more shielded tasks having a starting time within the overlap portion of the next period from the second database into the first database as a modification of the project scheduling data associated with the next period of the assignment plan.

It is noted that while the terms “first”, “second”, “third” etc databases have been used in the summary and the claims, the present invention is not limited to implementing separate databases, but may also be implemented by integrating the “first”, “second”, “third” etc database contents in a single database structure.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram illustrating various non-conversion activities existing in a conversion model.

FIG. 2 shows a schematic diagram illustrating interaction among multiple project processes.

FIG. 3 shows a schematic diagram illustrating the checking of constraint status in multiple stages.

FIG. 4 shows a schematic diagram illustrating the release triggers in push and pull production systems.

FIG. 5A shows a schematic diagram illustrating a project schedule without delays.

FIG. 5B shows a schematic diagram illustrating the project schedule remaining unchanged despite a delay in the delivery of a resource and information prerequisite.

FIG. 5C shows a schematic diagram illustrating delay of the project schedule due to the delay in the delivery of the resource and information prerequisite.

FIG. 5D shows a schematic diagram illustrating the use of pull-driven schedule approach in the example embodiment of present invention.

FIG. 6 shows a schematic diagram illustrating the steps of the constraint tracking method employed by the example embodiment of the present invention.

FIG. 7 shows a schematic diagram illustrating a Graphical User Interface (GUI) according to the example embodiment of the present invention.

FIG. 8 shows a schematic diagram illustrating a pulling buffer and a screening buffer in a look ahead plan window according to the example embodiment of the present invention.

FIG. 9 shows a schematic diagram illustrating a planned schedule being behind an advisory schedule in the Graphical User Interface of the example embodiment of the present invention.

FIG. 10 shows a schematic diagram illustrating a planned schedule being ahead of an advisory schedule in the Graphical User Interface of the example embodiment of the present invention.

FIG. 11 shows a schematic diagram illustrating planned schedule is aligned with an advisory schedule in the Graphical User Interface of the example embodiment of the present invention.

FIG. 12 shows a schematic diagram illustrating shielding point rules in task buffer management in the example embodiment of the present invention.

FIG. 13 shows a schematic diagram illustrating display and manipulation of the Graphical User Interface (GUI) workable backlogs and making work assignments according to the example embodiment of the present invention.

FIG. 14 shows schematic diagram of a system for constraint-based project scheduling in an example embodiment.

FIG. 15 shows a flowchart illustrating a method of constraint-based project scheduling according to an example embodiment.

FIG. 16 shows a schematic drawing of a computer system for implementing the method and system according to an example embodiment.

FIG. 17 shows a screen shot of a split screen GUI implemented in one example embodiment.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

Example embodiments of the present invention involve the use of an augmented precedence diagram method (APDM) or Augmented critical path method (ACPM) [see e.g. Chua, K. H. D., Shen, L. J., and Bok, S. H. (2003). Constraint-based Planning with Integrated Production Scheduler over Internet. Journal of Construction Engineering and Management. 129(3), 293-301], a constraint tracking method, and task buffer management for constraint-based planning and scheduling at the ‘pre-production’ stage, in particular the look-ahead and commitment planning stages in project planning. The methods and systems of the example embodiments may be utilised in various industries involving massive project management e.g. Construction, Manufacturing, Engineering, Research, etc. Implementations illustrated in the example embodiments may be integrated as a complement to project planning software such as Primavera, Microsoft Project or the like, or exist on its own as a project planning software.

In an example embodiment of the present invention, there is provided a constraint-based scheduling tool, hereinafter referred to as an Integrated Process Scheduler (IPS), for making reliable plans based on the principles of lean thinking [see e.g. Koskela, L. (1992). “Application of the new production philosophy to construction.” Tech Report No. 72, Center for Integrated Facility Engineering, Dept. Of Civil Engineering, Stanford University, CA., or Ballard, G. and Howell. G. (1998). “Shielding production: essential step in production control.” Journal of Construction Engineering and Management, ASCE, 124(1), 11-17] and theory of constraints [ see e.g. Goldratt, E. M. (1990), What is This Thing Called Theory of Constraints and How Should it be Implemented? North River Press, New York, N.Y.].

The lean thinking philosophy advocates eliminating hidden flows to improve project performance, in terms of quality of work plan, timeliness of delivery, and transparency of production monitoring and control, In particular, the focus of management extends from the traditionally improving task productivity to a more comprehensive transformation-flow-value view that reforms project management in a holistic way.

The theory of constraints discovered that only a small number of constraints are critical from the system point of view, though the rest may be locally important within a particular scope. Critical constraints greatly affect system performance in terms of reliability and productivity. In most cases, they are the binding factors on the system bottlenecks. Eliminating these constraints or reducing their variability can significantly improve the overall system performance. In other words, constraints are not equally important. Higher priority should be granted to the critical constraints, especially when the available resources are limited.

The IPS of the example embodiment can help to address project vulnerabilities due to uncertainties. It manages constraints hidden in, for example, the processes, the supply chain, and information flow, including constraints relating to quality, safety and contracts. Constraints that may cause bottlenecks can be effectively identified and removed in advance.

In the example embodiment a look-ahead plan is implemented as a number of task buffers arranged along a time axis of the look-ahead plan. Task buffer management is employed such that the position of any task is now determined not only by the precedence relationship in the project network, but also by the RI constraint status based on some task buffer policy. Each task buffer subjects the tasks to some policy to filter out unqualified tasks whose constraints status do not satisfy the rules. The tasks are prevented from advancing to subsequent buffers unless the constraint policy is satisfied. This consequently triggers the warning of delays electronically in the schedule. In order to pull the schedule to its original plan, management directives are enforced: either the RI constraints will be expedited or the schedule will be updated to reflect the current reality so that downstream workflow will not suffer from further disturbance.

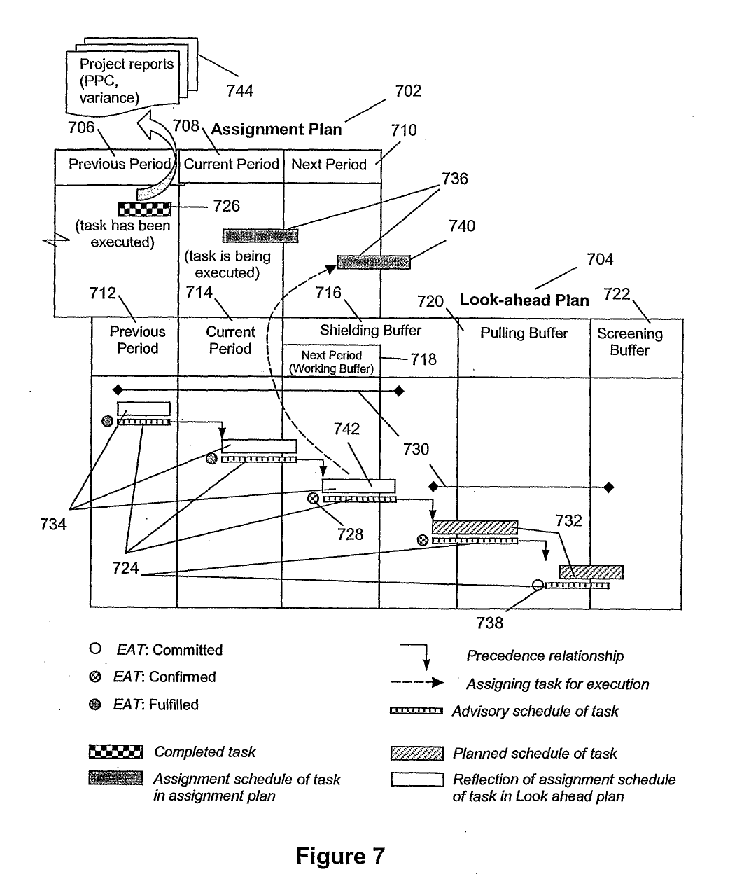

FIG. 7 shows a diagram of an example Graphical User Interface of the IPS in an example embodiment. FIG. 7 illustrates the workings of task buffers of the example embodiment. Task buffers are like time zones where different actions should be taken to move the plan ahead. Task buffers also control the movement of the tasks depending on the status of the constraints.

The Graphical User Interface (GUI) of the IPS comprises two independent windows, an assignment plan window 702 and a look ahead plan window 704. Windows 702, 704 are individual time charts displaying activities, tasks, constraints and the APDM path. A task is represent by a rectangular bar e.g. task 726. Constraints are represented by a dot e.g. dot 728. Activities 730 are placed above the tasks in the IPS GUI. The assignment plan window 702 comprises assigned activities, tasks and constraints. The look-ahead plan window 704 comprises assigned and unassigned activities, tasks and constraints. The assignment plan window 702 consists of a previous period section 706, a current period section 708, and a next period section 710. The look-ahead plan window 704 consists of a previous period section 712, a current period section 714, a shielding buffer 718 which comprises a next period section 716 (also referred to as working buffer), a pulling buffer 720, and a screening buffer 722.

As such, the assignment plan 702 and the look-ahead plan 704 are displayed in a “split” fashion on the GUI, with a temporal “overlap” including an overlap for the next period 710 of the assignment plan 702, with the next period or working buffer portion 718 of the shielding buffer 716 of the look-ahead plan 704. It will be appreciated that the split display may be implemented in a number of different ways, including side-by-side, concatenated etc. and is not limited to the arrangement depicted in the drawings in this description.

The previous period sections 706, 712 of the assignment and look-ahead plans respectively store the historical data of previous weeks or days, depending on the time frame defined by user. The current period sections 708, 714 of the assignment and look-ahead plans respectively represent the current working week in which the purpose is to achieve smooth production and high Percent Plan Completion (PPC), that is the percent of tasks in the assignment plan 702 that is completed with respect to the number of assigned tasks.

There are three types of task schedules represented on the GUI of the example embodiment, namely an advisory schedule as represented by the advisory path task bars 724, a planned schedule as represented by the sequence of tasks 734, 732 in the look-ahead plan 704, and an assignment schedule as represented by the sequence of tasks 726, 736 displayed on the assignment plan 702.

The advisory schedule or path 724 is typically an early start path computed based on the augmented critical path method (ACPM) or the augmented precedence diagram method (APDM). In the example embodiment, the APDM is used. The advisory schedule 724 represents a feasible and reliable schedule accounting for the precedence relationships of tasks and the availabilities of RI constraints. The planned schedule 732 represents an independent fine-tuned production schedule on top of the advisory schedule 724. The assignment schedule 736 in the assignment plan window 702 is created once tasks in the look-ahead plan window 704 are assigned for execution. The assignment schedule 736 is not necessarily the same as the planned schedule 734. It depends on resource availability or other considerations at the time of making the assignment. In FIG. 7, tasks 734 of in the look-ahead plan 704 indicate the tasks already assigned to the assignment plan window 702. Furthermore, the tasks 734 on the look-ahead plan 704 can no longer be directly adjusted in the look-ahead plan 704. The control of those tasks has been transferred to the assignment plan 702, where the corresponding tasks e.g. 736 may still be adjusted due to changes in resources or other conditions on site, with the task being updated with the actual start and completion in the assignment plan 702. Changes that are made to those tasks in the assignment plan 702, would still be “mirrored” back into the look-ahead plan 704.

Having the assignment and look-ahead plans in two separate windows and with a temporal overlap advantageously enhances project schedule displaying for improved visualisation and comprehension of the project flow and can aid in ensuring that constraints are resolved and resources are available for each task requiring certain resources before commencement. The look ahead window 704 displays a workable backlog which the user can view and make contingency plans. In contrast, having a backlog being pushed directly in a continuously displayed combined assignment and look-ahead plan, i.e. with no temporal overlap between the assignment and look-ahead plan, in practice often causes contingency planning to involve delaying tasks “at the least minute” at the boundary between the assignment plan and the look-ahead plan, without a convenient visualization and assessment opportunity for possible follow-on effects and/or workable task flow solutions. Furthermore, in the example embodiment, the displayed advisory schedule advantageously facilitates the user coming up with a reliable plan by providing advice that takes into consideration constraints.

In the example embodiment, statuses of constraints are either committed, confirmed or fulfilled. ‘Fulfilled’ means the constraint has already been resolved e.g. a promised resource has been delivered. ‘Committed’ means that the constraint has just been created or a promise or plans (without guarantees) for resolving the constraint has been made e.g. a contract with fixed deadline to deliver a certain resource is made that is subject to change due to certain hidden flows. ‘Confirmed’ is the status where there is full confidence that the constraint can be resolved but is not yet resolved e.g. it is guaranteed by the vendor that the resource will be delivered on time but has not yet been fulfilled. For example, in FIG. 7, constraint 728 is confirmed but not fulfilled. Since constraint 728 is confirmed, task bar 742 associated with constraint 728 has been transferred to the assignment plan window 702 as task bar 740. An example for committed is constraint 738. Here, the fact that the advisory path task bar 740 is not synchronised with the planned schedule task 732b highlights or alters the project manager to an opportunity to move forward the planned task 732b, i.e. in anticipation that constraint 738 will be committed in time.

In addition, data pertaining to all executed tasks (e.g. task bar 726) will be archived and can be used for generating project reports 744 such as Percent Plan Completion Reports, Variance Reports, ‘To Do’/Watch list of constraints, Key Constraint reports, full Constraint Watch List Summary, etc. Similarly, the reports can be generated from the look-ahead plan 704, and such reports may be used to guide discussion on the work ahead. Reports on the assignment plan for the next period can also be generated to guide site work.

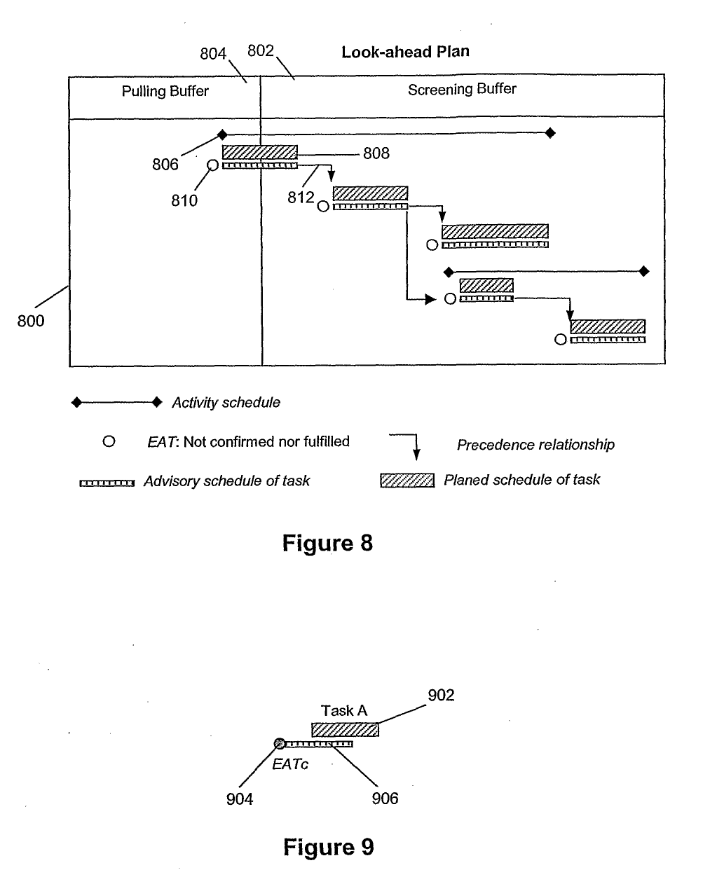

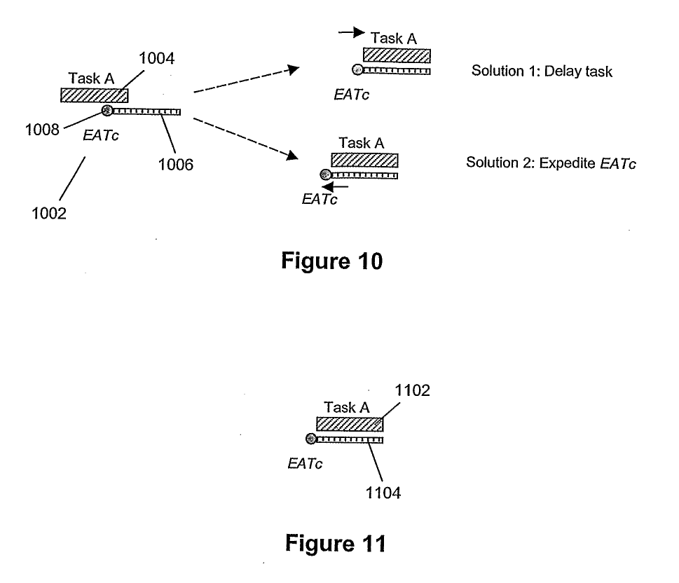

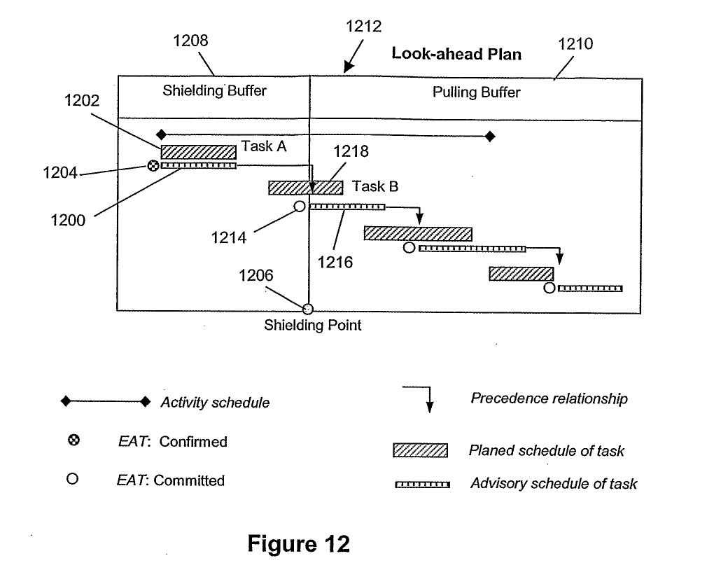

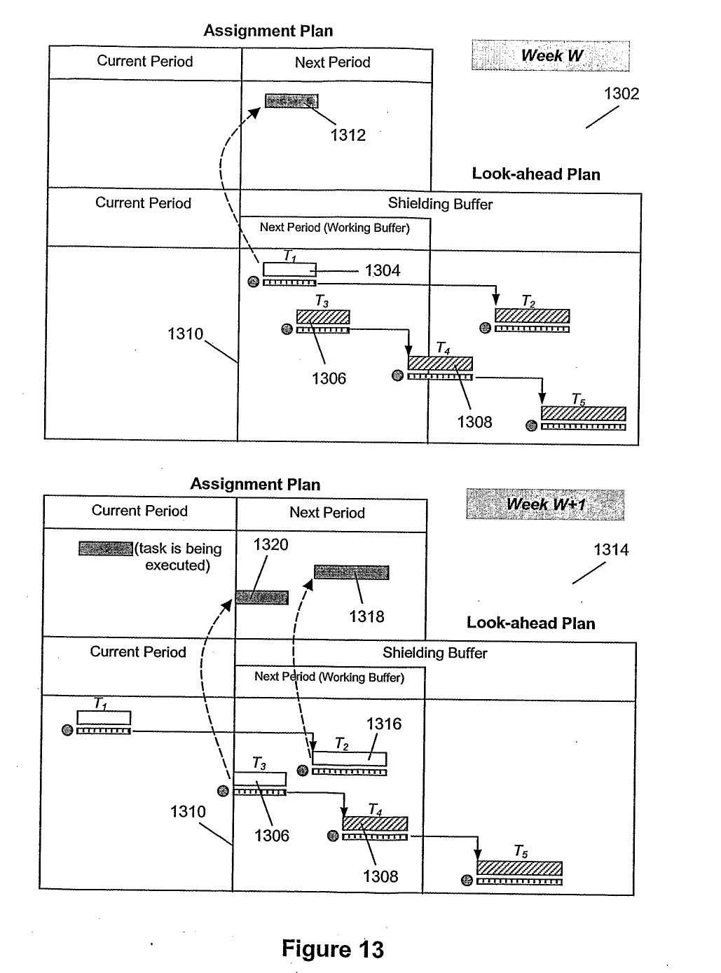

The purpose and features of each task buffer in the example embodiment will now be further described.
Screening buffer
FIG. 8 shows a pulling buffer 804 and a screening buffer 802 in a look-ahead plan window 800. The screening buffer 802 contains high-level activities (e.g. activity 806) either created in the IPS or imported from the phase or master plan of a project management software e.g. Primavera, MS Project etc. These activities are generally not suitable for production scheduling and control because they usual comprise smaller task that have to be executed on site and each of this in turn have additional information (e.g., resources, drawings, methodology, etc) that is required before they can be executed. Therefore, each activity is broken down to a group of executable tasks (e.g. task bar 808, which is broken down from activity 806). This step requires domain knowledge to properly describe the size, sequence, and content of task definition. Meanwhile, the prerequisite RI (resource and information) constraints (e.g. unconfirmed constraint 810), where applicable, are identified.
Pulling buffer
Referring back to FIG. 7, the pulling buffer 720 plays an important role in the look-ahead planning. The sequence of work tasks is structured according to construction methodology and precedence. Further, the verificative parameters of constraint status are determined and associated with RI constraints. Also, EATs for prerequisite constraints are either set for or requested from project participant. From this point onwards, the status of each RI constraint prior to the estimated available time (EAT) is monitored. Additionally, an advisory schedule can be obtained through the method of ACPM or APDM, therefore a feasible and reliable schedule is always available as guidance for reliable project scheduling. Advanced constraint analysis (e.g., the key constraint analysis) can also be carried out to identify critical constraints so that it is possible to reduce or eliminate project delays.
FIG. 9 shows a Task A 902, which is part of the planned schedule in the Pulling Buffer of a look-ahead window. Constraint 904 with EATS is associated with Task A 902 and is confirmed. Task bar 906 is part of the advisory schedule. In FIG. 9, Task A 902 is to the right of Task bar 906, thus falling behind Task bar 906, which means the planned schedule is falling behind the advisory schedule. The advisory schedule in this case indicates that there is an opportunity to move Task A 902 to the left i.e. move forward to where Task bar 906 starts. Hence, the project manager may “listen” to advisory schedule's advice and move Task A 902 forward to where Task bar 906 starts, and thus advance the task.
The scenario 1002 in FIG. 10 shows that Task A 1004 is ahead of advisory Task bar 1006. Based on the advisory schedule in this scenario, Task A 1004 cannot be achieved earlier than the advisory schedule because constraint 1008 will cause Task A 1004 to be delayed. There are two possible project management solutions for scenario 1002, which are illustrated in scenarios 1010 and 1012. Solution 1 scenario 1010 suggests that Task A 1004 be delayed to start at the same time as the advisory schedule. Solution 2 scenario 1012 suggests that the time of completion/delivery EAT_{C} of the constraint 1008 be expedited so that the advisory schedule will reflect that Task A 1004 is feasible. In any case, the advisory schedule provides the means to improve plan reliability through such actions as described.
FIG. 11 shows that Task A 1102 is aligned with Task Bar 1104, i.e. the planned schedule is the same as the advisory schedule. Since the, schedules are aligned, there are no project management problems with the scenario in FIG. 11.
Shielding buffer
Referring back to FIG. 7, the role of the shielding buffer 716 is to reduce the impact of uncertainties caused by prerequisite constraints in the hidden work flow. The key concern here is to ensure that RI constraints are smoothly resolved so that each task is ready to be assigned for execution.
The shielding buffer 716 contains an overlap portion (i.e. overlap with the next period section 710 in the assignment plan 702) called the next period section 710 (also referred to as working buffer or workable backlog herein), which contains tasks (e.g. Task bar 742) to be assigned as executable tasks (e.g. Task bar 740) in the assignment plan. “Next period” is a relative term to “current period”. It could mean “next few days”, “next week”, “next few weeks” etc., depending on the size of the shielding buffer 716, which is determined by the user of the IPS. The purpose of having the next period section 710 is to form a workable backlog with sufficient tasks ready for assignment.
With reference to FIG. 12, further details for the action of the shielding buffer will now be described. For the advisory path task bar 1200 of task A 1202, the constraints 1204 are confirmed or fulfilled so that task A 1202 has been moved passed the shielding point 1206 between the shielding buffer 1208 and the pulling buffer 1210 of a look-ahead plan window 1212. On the other hand, the constraints 1214 for the advisory path task bar 1216 of task B 1218 are not all confirmed or fulfilled. Here, it is noted that the marker illustrating the constraints 1214 may represent the latest EAT of many constraints.
Because of the buffer rules applied in the example embodiment, the advisory path task bar 1216 is blocked at the shielding point 1206, i.e. it will not advance into the shielding buffer 1208. However, task B 1218 still advances into the shielding buffer 1208 as the real time progresses, but the advisory path, in particular task bar 1214 relative to task B 1218 will advantageously indicate and highlight to the project manager that the original plan schedule is no longer feasible because the corresponding constraints 1214 are not resolved. It is noted that as a result of the blocking of the task bar 1216 at the shielding point 1206, the downstream advisory schedule is also affected, which will reflect the delay caused by the unresolved constraint 1214 of task B 1218. Therefore, the shielding point 1206 with its associated buffer rules advantageously provides the mechanism to allow the project manager to make reliable plans. In other words, an advisory schedule or path that proceeds beyond the shielding point 1206 and into the shielding buffer 1208 has constraints fulfilled or confirmed, therefore providing the project manager with an advisory or reference schedule in the shielding buffer 1208 that represent a workable backlog.
FIG. 13 illustrates workable backlogs and how to make work assignments in the example embodiment. In week W (see top diagram 1302), three tasks, T₁ 1304, T₃ 1306, and T₄ 1308, are disposed with starting times in the workable backlog 1310 and are ready for assignment, but only T₁ 1304 is assigned as task bar 1312 in the assignment plan because of, for example, limited resources being delivered. In the following week W+1 (see bottom diagram 1314), the look-ahead plan is updated. Now, the workable backlog 1310 contains again three tasks that are ready for assignment i.e. T₂ 1316, which has been moved into the next period since week W, T₃ 1306, and T₄ 1308. In week W+1, two tasks, T₂ 1316 and T₃ 1306 are assigned as Task bar 1318 and 1320 respectively in the assignment plan, with T₄ remaining due to e.g. resource shortage. If it later turns out that T₂ 1316 can not be executed, for example, due to unforeseen circumstances, then T₄ 1308 in the workable backlog can be assigned and executed instead.
It is noted that, before to being assigned, the advisory path task bar 1307 of T₃ 1306 would be blocked from entering the current period 1322 of the look-ahead plan 1324. As a result of the blocking of the advisory path task bar 1307, the down stream activities advisory path task bars such as task bar 1326 of T₄ 1308, and task bar 1328 of T₅ would also be affected accordingly.

An example work flow a user may adopt when using the IPS of the example embodiment is as follow:
a. create or import activities into the screening buffer. Note that activity can still be added in any buffer as project proceeds
b. break down activity to task level (this signals the changing of perspective to production planning)
c. create or import constraint library
d. identify constraints for each task, where applicable
e. Use advisory schedule to determine reliable plan and analyze the impact of delays and schedule conflicts. This include: 1) delay of prerequisite constraints, 2) delay of upstream workflow, 3) a combination of both 1) and 2)
f. apply key constraint analysis to identify “bottleneck constraints”, if any delay need to be resolved
g. monitor constraint statuses and take proactive directives (eg expediting EAT of constraints or re-scheduling) to solve the schedule delays or conflicts
h. use advisory schedule to serve as a guidance for assignment plan.
i. make sure a task enters the shielding buffer only after the availabilities of its prerequisite constraints are confirmed. Discrepancies will be indicated by the advisory schedule being blocked as at the shielding point.
j. obtain a list of executable tasks in the “next period”, which form the workable backlog
k. assign (or waive) resources to the tasks in the workable backlog. Task not assigned remain in the workable backlog for the next week to allow for contingency planning when necessary.
l. after assigning a task, the assignment schedule appear across the split window
m. the assignment plan is distributed to project participants and the focus of management now is shifted to production control of the assignment plan.
n. Monitor project progress and update the weekly work plan. Various project reports (e.g. PPC and variance) are to be generated
o. Learning from mistakes seen in the project reports
p. Repeat the above processes

The example embodiment described above also incorporates integrated constraints in low-level plans (i.e., look-ahead plan and commitment plan) to model hidden resource and information flows and perform schedule analysis using the APDM or ACPM. The augmented path based on either type of analysis provides advisory information to manage the task and constraints. A pull driven schedule control workflow is implemented through proactively tracking constraint status, selectively expediting certain key constraints, and shielding pre-production work tasks from uncertainties prior to work assignments. A series of task buffers (namely, screening, pulling, and shielding) are employed and customized buffer policies can be assigned to discipline the rules for constraint management, which eventually help achieve reliable plans and better project performance [ see e.g. Chua, K. H. D., Shen, L. J., and Bok, S. H. (2003). Constraint-based Planning with Integrated Production Scheduler over Internet. Journal of Construction Engineering and Management. 129(3), 293-301, or Chua, K. H. D., and Shen, L. J. (2001). Constraint Modeling and Buffer Management with Integrated Production Scheduler. Proceeding of 9th International Conference on Lean Construction, the National University of Singapore]. Compared to existing uses of ADPM or ACPM however, in using the ADPM or ACPM as an advisory path or schedule in conjunction with the split display of overlapping assignment and look-ahead plans in the example embodiments facilitates identification of suitable work flows in project planning.

The IPS of the example embodiment facilitates a method of identifying schedule constraints, creating a constraint library, tracking constraint status, analyzing constraint impact, resolving constraints in multiple stages, expediting key constraints, and establishing reliable work plans attributed to the proactive constraint management workflow. A series of task buffers are defined by the IPS and buffer policies are disciplined to determine realistic task schedules according to the constraint status. With a focus on pre-production planning and scheduling, the IPS provides an integrated environment for constraint identification, classification, tracking, analysis, scheduling, and reporting. Hence, advantageously, uncertainties and conflicts are reduced, smooth production workflow is achieved, and plan reliability is enhanced.

To cope with uncertainties in, for example, a construction process, two measures are often adopted. One is increasing capacity at the right places. The other is adding temporal buffers (or inventories) big enough to reduce disruptions. However, these measures not only demand additional cost but also conceal the real problems that result in uncertainties and delays. Relying too much on redundant capacity and time buffers (as opposed to task buffers in the example embodiments) would inevitably introduce wastage in the process. Moreover, in many cases it is difficult to detect where the bottlenecks in a project are located and how they are formed. In the long run the two measures become ineffective.

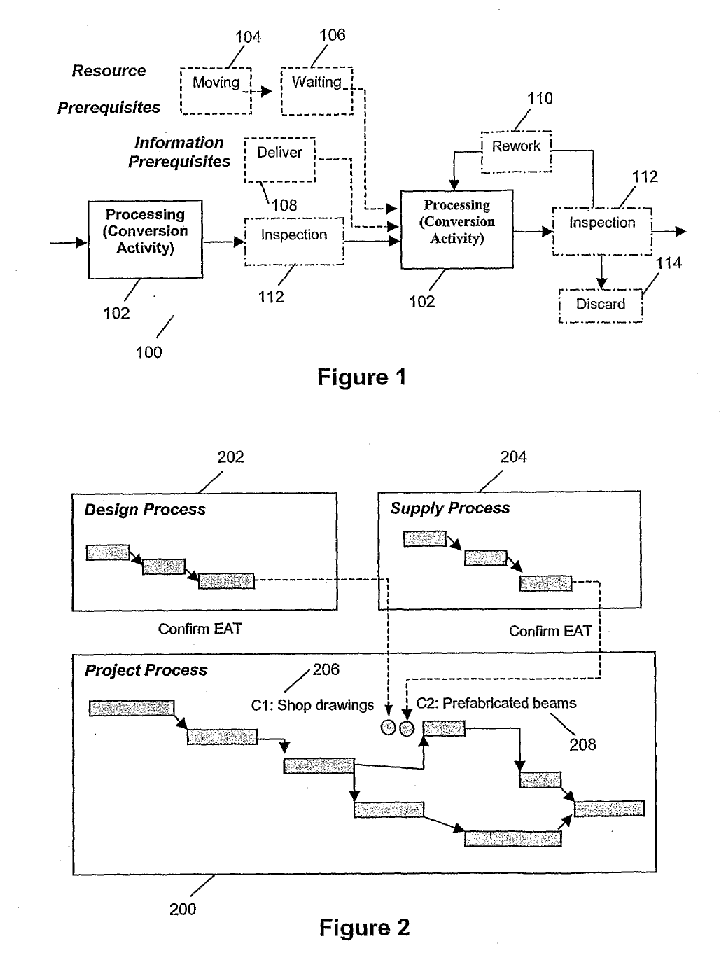

In order to systematically get rid of uncertainties, the intrinsic causes should be examined. The conventional view of a project (especially in the construction industry) is represented as a conversion model [ see e.g. Koskela, L. (1992). “Application of the new production philosophy to construction.” Tech Report No. 72, Center for Integrated Facility Engineering, Dept. Of Civil Engineering, Stanford University, CA], in which many other indispensable elements in the project process are absent. One of the missing components in a conventional view of a project is the resource flow, which comprises a series of (non-conversion) activities representing the moving and waiting of resources before being processed, and thereafter inspected. Another instance is the information flow, which consists of (non-conversion) activities related to the deliveries of plans, drawings, and request-for-information (RFI). Other non-conversion activities include inspection, rework, and discard as shown in FIG. 1, which are all necessary and should not be ignored.

FIG. 1 illustrates various (non-conversion) activities existing in a conversion model 100. Processing 102 is a conversion activity. Moving 104 and Waiting 106 are non-conversion activities that are resource prerequisites for Processing 102. Delivery of plans 108 is a non-conversion activity that provides information for the Processing 102. Other non-conversion activities in the conversion model 100 are Reworking 110, Inspection 112 and Discarding 114. Other non-conversion processes can include safety, quality, contract etc.

In the example embodiment, identifying these “hidden” flows, i.e. the resource flow and information flow, enables to employ a better strategy in handling process uncertainties.

An effective way adopted by the example embodiment to diminish uncertainties is to invest in flow reliability [ see e.g. Koskela, L. (1992). “Application of the new production philosophy to construction.” Tech Report No. 72, Center for Integrated Facility Engineering, Dept. Of Civil Engineering, Stanford University, CA., or Koskela, L. (2000). An exploration towards a Production Theory and its Application to Construction. VTT Technical Research Center of Finland]. In the IPS framework, the Resource and Information (RI) availabilities representing flow constraints are incorporated in the schedule to improve plan reliability. Here, it is noted that IR is used as a generic term for flow constraints not limited to resources and information, but also including e.g. safety, quality, contracts etc.

As schematically illustrated in FIG. 2, a construction process 200 in a project may interact with two external and traditionally hidden processes, e.g. design 202 and material supply 204, through the interface of flow constraint availabilities in terms of estimated available time (EAT). Constraints C1 206 and C2 208, for example, represent two RI prerequisites, workshop drawings and prefabricated beams, whose EAT are acquired from the corresponding design and supply processes, respectively. Uncertainties in these supporting processes may affect the EAT and subsequently alter the construction schedule. Likewise, changes in the construction schedule may impact the external processes. Therefore, it is necessary to capture this interdependency in the schedule so that it is feasible to determine the real causes of uncertainties and take actions to minimize the adverse impact.

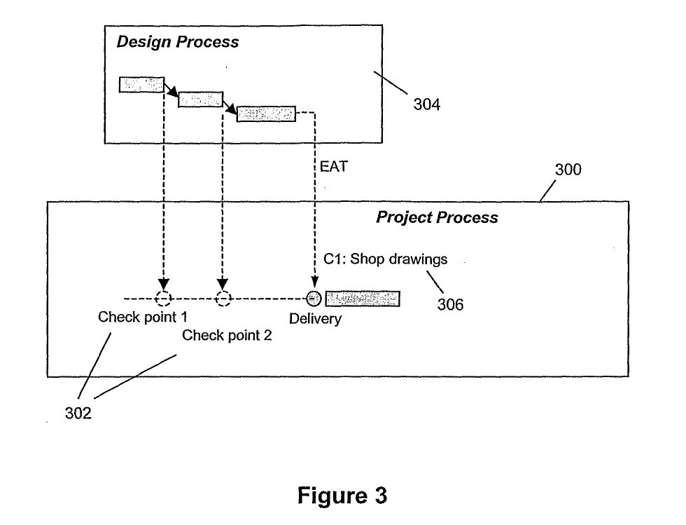

The status of flow constraints can be monitored in the IPS as the constraints progress through multiple stages prior to delivery. FIG. 3 illustrates the checking of constraint status in multiple stages at the IPS. In FIG. 3, a project process 300 interacts with an external design process 304 that produces workshop drawings C1 306 for the next step in the project to continue after the drawings 306 have been delivered. At each checkpoint 302 of the design process 304, the status of the flow constraint is examined. If any delay is detected at the checkpoints 302, the necessary management directive can be issued to remedy the situation.

By implementing the checking of constraint status, the approach of project management changes from a push to a pull scheduling approach. In a manufacturing process, a push system releases a job precisely according to the prescribed schedule, which is made based on the forecast of demand and remains unmodified within a period of time no matter what is happening in the process. A pull system releases a job according to the request from downstream processes. In practice, the push system may be less effective when the demand varies frequently and radically. The pull system, on the other hand, is not easy to be implemented but can be much more effective when the demand fluctuates. Most real-world systems may have aspects of both push and pull [ see e.g. Hopp, W. J., and Spearman, M. L. (1996). Factory Physics: Foundations of Manufacturing Management. Irwin/McGraw-Hill, Boston, Mass.]. Similarly in a project, a push driven scheduling approach only works well when processes are very stable, which might not be the case in most complex work flow. The pull driven scheduling approach via proactively tracking constraint status and deploying preemptive measures in the example embodiment can be more flexible and effective in its response to delays and disruptions. It shifts the focus of management, from activities alone to both activities and flow constraints. Therefore, implementing a pull approach in the example embodiment greatly increases the opportunity to prevent potential flow problems from disturbing the main project process.

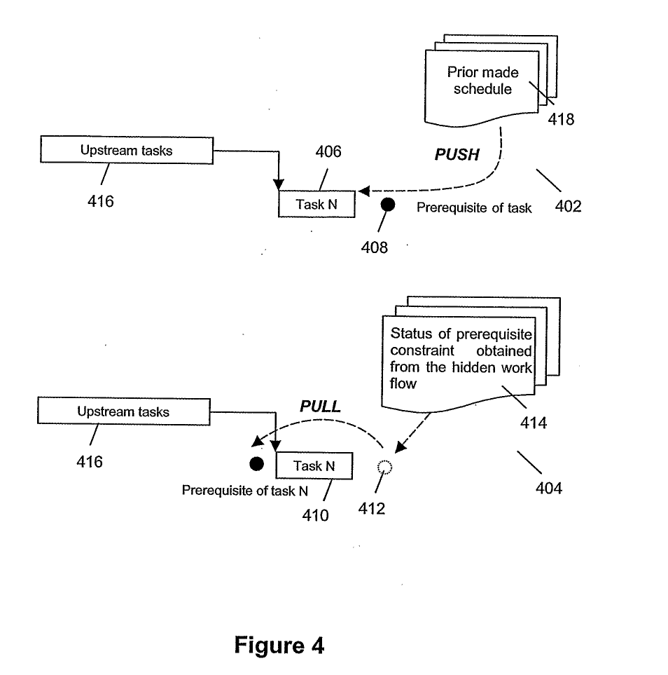

For example, in a construction process, the contrast between push and pull systems is depicted schematically in FIG. 4.

In FIG. 4, Upstream tasks 416 are precedent tasks taking place before Task N 406, 410. In the push system 402, task N 406 is assigned following a prior made schedule 418. However, the schedule of task N 406 is not valid because its prerequisite 408 is delayed but unfortunately the problem was not detected promptly, because it is not explicitly incorporated into the schedule, unlike in the example embodiment. This will inevitably result in schedule disruption, which could have been avoided if the delay of prerequisite 408 was reported earlier. On the other hand, such problem could be resolved more effectively in the pull system through proactively tracking constraint status 414 from the hidden workflow and expediting (or pulling) the prerequisite constraint 412 of Task N 410 to reduce the impact of contingency, when necessary.

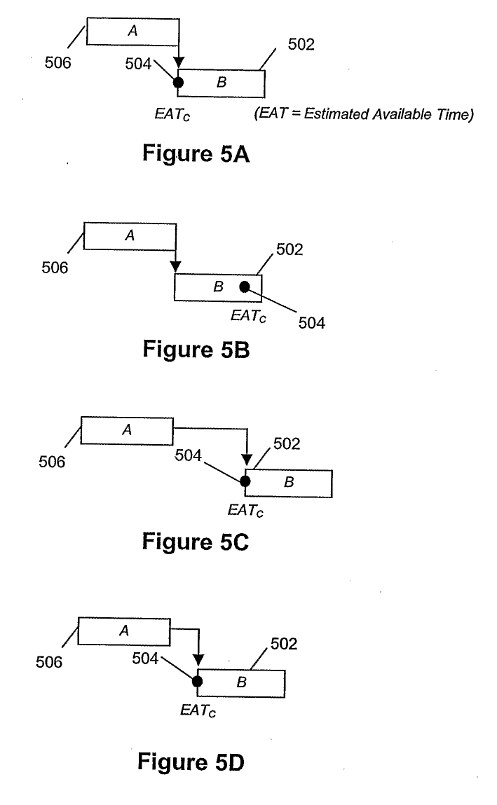

The pull-driven schedule control is valuable for providing a better alternative to counteract uncertainties from the flow constraint perspective. FIG. 5 illustrates the differences between push and pull schedule control. FIG. 5A represents a project schedule in which on completion of task A 506, in order for task B 502 to commence, a

RI prerequisite C has to be delivered at EAT_{C} 504. Say for some reason, the delivery of RI prerequisite C is delayed, hence EAT_{C} 504 is delayed as indicated in FIG. 5B. If working with a push-driven schedule, this delay may not be promptly identified and the original project schedule remains. As a result, task B 502 would be inevitably delayed as illustrated in FIG. 5C due to the delay in EAT_{C} 504. This delay may cause schedule disruption to every organization involved in task B 502, which consequently may impact the downstream workflow as well.

The example embodiment resolves such a problem in push schedule control by adopting the pull-driven schedule approach. That is, to detect the delay of EAT_{C} 504 earlier and assess if prerequisite C can be expedited to alleviate the delay of task B 502. If, for example, EAT_{C} 504 can be expedited (or pulled) to an earlier time as shown in FIG. 5D and all the organizations involved are informed of the new schedule, then not only the delay can be reduced (or eliminated) but also better coordination can be achieved.

In the example embodiment, an Augmented Precedence Diagram Method (APDM) formulated using the concept of incorporating flow constraints (or RI constraints) in the conventional PDM to enhance schedule reliability is used instead of the existing ACPM.

The resulting schedules based on the APDM are more robust because uncertainties in terms of the RI constraints (of hidden flows) are explicitly identified and mitigated upon analysis, and subjected to the additional start and finish precedence constraints.

The following is a list of definitions for the variables used in the equations for APDM in the following description of the example embodiment.

Ti indicates Preceding Task i

Tj indicates Succeeding Task j

ES indicates Early start time, i.e. the earliest time a task can begin, subject to any time constraints (not incorporating RI prerequisite constraints).

LS indicates late start time, i.e. the latest time a task can begin without delaying the project (not incorporating RI prerequisite constraints).

LF indicates late finish time, i.e. the latest time a task can be finished without delaying the project (not incorporating RI prerequisite constraints).

FS indicates Finish to start precedence constraint, i.e. the task can only start after a specified minimum amount of time has elapsed after the preceding task has finished.

SS indicates Start to start precedence constraint, i.e. the task can only start after a specified minimum amount of time has elapsed after the preceding task has started.

SF indicates Start to finish precedence constraint, i.e. the task can only finish after a specified minimum amount of time has elapsed after the preceding task has started.

FF indicates Finish to finish precedence constraint, i.e. the task can only finish after a specified minimum amount of time has elapsed after the preceding task has finished.

FF also indicates Initial time, i.e. the earliest start time of any task in the project network.

FF also indicates Terminal time, i.e. the latest finish time of any task in the project network.

D indicates Task duration

EAT indicates Estimated available time, i.e. the expected time that a RI prerequisite constraint is fulfilled.

ES′ indicates Modified early start time, i.e. the earliest time a task can begin, subject to any time constraints incorporating RI prerequisite constraints.

The scheduled start time Sⱼ for any task Tⱼ in a project P is determined by the following condition to avoid delay in project completion:

ESⱼ≦Sⱼ≦LS_{j′} ∀Tⱼ⊖P (1)

where

$${ES}_{j} = {MAX}_{all i} \{ \begin{matrix}\begin{matrix}\begin{matrix}\begin{matrix}INITIAL TIME \\ {EF}_{i} + {FS}_{ij}\end{matrix} \\ {ES}_{i} + {SS}_{ij}\end{matrix} \\ {EF}_{i} + {FF}_{ij} - {D}_{j}\end{matrix} \\ {ES}_{i} + {SF}_{ij} - {D}_{j}\end{matrix} \}$$

is the early start time of Tⱼ, in which EFᵢ=ESᵢ+Dᵢ is the early finish time of Tᵢ, Tᵢ being the predecessors of Tⱼ; Dⱼ denotes the Duration of Tⱼ; LSⱼ=LFⱼ−Dⱼ is the late start time of Tⱼ, in which

$${LF}_{j} = {MIN}_{all k} \{ \begin{matrix}\begin{matrix}\begin{matrix}\begin{matrix}TERMINAL TIME \\ {LS}_{k} - {FS}_{jk}\end{matrix} \\ {LF}_{k} - {FF}_{jk}\end{matrix} \\ {LS}_{k} - {SS}_{jk} + {D}_{j}\end{matrix} \\ {LF}_{k} - {SF}_{jk} + {D}_{j}\end{matrix} \}$$

where LSₖ is the late start time of Tₖ, the successor of Tⱼ. FS, FF, SS, and SF denote the finish-to-start, finish-to-finish, start-to-start, and start-to-finish precedence constraints, respectively.

Incorporating the RI constraint parameters, the APDM can be depicted as:

ES′ⱼ≦Sⱼ≦LS′ⱼ ∀Tⱼ⊖P (2)

where ES′ⱼ is the modified early start time of task Tⱼ to account for reliable plan. The forward path considers the project start, precedence, EATⱼₗ and task start conditions. ES′ⱼ is given by,

$${ES}_{j}^{′} = MAX \{ \begin{matrix}{MAX}_{all i} \{ \begin{matrix}\begin{matrix}\begin{matrix}\begin{matrix}INITIAL TIME \\ {EF}_{i}^{′} + {FS}_{ij}\end{matrix} \\ {ES}_{i}^{′} + {SS}_{ij}\end{matrix} \\ {EF}_{i}^{′} + {FF}_{ij} - {D}_{j}\end{matrix} \\ {ES}_{i}^{′} + {SF}_{ij} - {D}_{j}\end{matrix} \} \\ {MAX}_{all l} ( {EAT}_{jl} ) \end{matrix} \} ,$$

subject to “task start condition” (3a)

Task start condition here include conditions such as “must start on”, “must start before”, “must start no later than” etc and also non-working day conditions.

in which EATⱼₗ represents the estimated available time for the l^{th} constraint of task Tⱼ. EF′ⱼ, LS′ⱼ, and LF′ⱼ are the modified early finish, late start, and late finish, respectively,

EF′ⱼ=ES′ⱼ+Dⱼ, and (3b)

The backward path considers project finish and precedence. LF′ⱼ is given by,

$$\begin{matrix} {LF}_{j}^{′} = {MIN}_{all k} \{ \begin{matrix}\begin{matrix}\begin{matrix}\begin{matrix}TERMINAL TIME \\ {LS}_{k}^{′} - {FS}_{jk}\end{matrix} \\ {LF}_{k}^{′} - {FF}_{jk}\end{matrix} \\ {LS}_{k}^{′} - {SS}_{jk} + {D}_{j}\end{matrix} \\ {LF}_{k}^{′} - {SF}_{jk} + {D}_{j}\end{matrix} \} & ( 3 c ) \\ {LS}_{j}^{′} = {LF}_{j}^{′} - {D}_{j} & ( 3 d )\end{matrix}$$

In the above calculation, the APDM explicitly accounts for the constraints in the hidden flow through the EAT which would otherwise be omitted from the traditional PDM or CPM computations. The early and late times provided by the APDM gives the advisory schedule taking into consideration the RI availabilities so that the plan can be made more reliable.

In the example embodiment, a canvas view calculation modification of the APDM is performed as the schedule is displayed on the canvas (i.e. the GUI implemented as described above). This modification is based on the task buffer policies, i.e. subjecting the task to the filters based on the constraint status as described above.

In the example embodiment, the forward path considers project start, precedence, EATⱼₗ, task start conditions and buffer policy (to be discussed subsequently). EF′ⱼ is given by,

$${ES}_{j}^{′} = MAX \{ \begin{matrix}{MAX}_{all i} \{ \begin{matrix}\begin{matrix}\begin{matrix}\begin{matrix}INITIAL TIME \\ {EF}_{i}^{′} + {FS}_{ij}\end{matrix} \\ {ES}_{i}^{′} + {SS}_{ij}\end{matrix} \\ {EF}_{i}^{′} + {FF}_{ij} - {D}_{j}\end{matrix} \\ {ES}_{i}^{′} + {SF}_{ij} - {D}_{j}\end{matrix} \} \\ {MAX}_{all l} ( {EAT}_{jl} ) \end{matrix} \} , \\ subject to \{ \begin{matrix}task start condition \\ buffer policy\end{matrix} \} \qquad ( 4 )$$

Using Canvas View Calculation, the backward path considers project finish and precedence. LF′ⱼ remains the same as equation 3c.

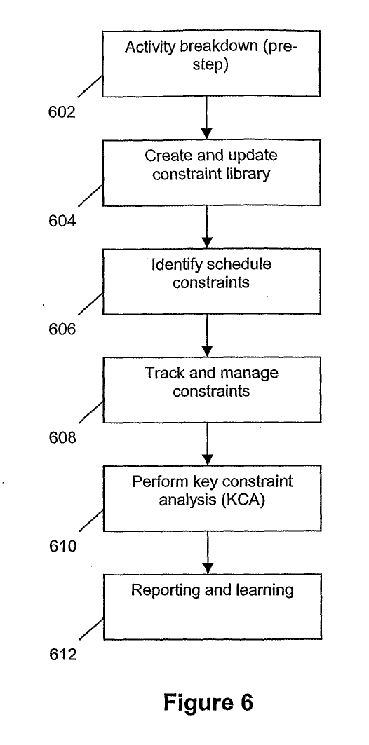

In the example embodiment, constraint tracking and resolving represent repetitive iterations at the low-level planning stage to identify and manage hidden flows. It is achieved through the concept of verificative parameters to represent the hidden flow (diagrammed in FIG. 3 as constraint checkpoints 302) with the final fulfilment of the constraint represented as an EAT. These verificative parameters lead to the status of the constraint so that the constraint progresses through intermediary states from a committed state in the beginning to a fulfilled state eventually. Constraint tracking forms the crucial steps of constraint-based scheduling. The steps of the constraint tracking method employed by the example embodiment are illustrated in FIG. 6 and described as follows.
Activity breakdown (pre-step)
At step 602, high-level activities are broken down into smaller tasks. This is because the content of constraint management is dependent on the scope of planning. High-level activities are suitable for master and phase planning but at pre-production planning levels, executable tasks (or sub-activity or steps or job orders) are more appropriate. After breaking down the activities, the precedence relationships of tasks are assigned.
Create and update constraint library
Step 604 involves creating a constraint library or database and updating the constraint library. A constraint library predefines the template of constraint source, management type, and verificative parameters. A constraint library typically consists of several sources defined by departments or disciplines, e.g., contract, engineering, procurement and construction. Each source is characterized by several management types, which define the way the constraint is to be managed, which in turn is represented by the verificative parameters. Each verificative parameter defines a checkpoint for constraint status tracking. For example, the engineering category may have a management type called drawings and the drawings may comprise six verificative parameters: preparation, details, approval, construction, vendor drawing, and data sheet. Preparation would denote a committed status for the constraint while data sheet would denote the fulfilled status. Thus, these parameters indicate the current status of the constraint, which determines its position in the task buffers (to be discussed subsequently).
Identify schedule constraints
Step 606 involves that identifying and associating constraints from the constraint library to the tasks. Generally, these constraints are anything that would hinder or disrupt the execution of a planned task. Essentially, they help manage the hidden flows that are often times missed. Usually, common resources that can be easily acquired or substituted are not worthwhile to be included as constraints. The available time of each RI constraint to be fulfilled is estimated and incorporated as the EAT.
Track and manage constraints
Step 608 is the process of managing the tasks and the constraints for flow reliability. From this point, realistic task schedule is determined by using the APDM. The APDM acts as the advisory schedule for the planned task. Tasks that run ahead of the APDM (or augmented path) are not reliable since the constraints can only be fulfilled after the planned start of the tasks. In this case, two actions are possible: expedite the constraint so that the plan becomes realistic or delay the task to be in line with the augmented path.
A watch list or to-do list of consolidated constraints is also generated at step 608 to provide the constraint status and responsible party so that the necessary actions may be taken to resolve the constraints before the EAT date.
Perform key constraint analysis (KCA)
At step 610, key constraint analysis (KCA) is performed.
The key constraint analysis (KCA) algorithm follows the theory of constraint principles to generate a list of critical RI constraints (namely, key constraints) through evaluating constraint floats. The KCA allows for unambiguously determining the priorities of RI constraints to the project goal (e.g., shorter project duration). It is observed that only the key constraints need to be expedited to improve project performance. The KCA provides an optimal solution in constraint management, especially under the circumstances where available resources are limited and competitive.
KCA helps locate bottleneck constraints and make optimal solutions to reduce project delays. The result is a list of key constraints to be expedited in multiple steps. This together with the constraint list (watch list or to-do list) forms the basis for expediting and making the flow reliable.
Reporting and learning
Step 612 involves reporting information on systemic variations, for example, delays in processes, errors occurred, etc and learning from the information, for example, correcting or notify of the same errors in a similar project before the errors occur. The earlier steps provide the means to manage uncertainties in the project schedule electronically. Total constraint management requires corrective measures on systemic variations in the project as well. Variations in the assignment plan become the basis for continual improvement of the project system so that future systemic failures can be corrected. This can be achieved by noting the reasons for variations of actual execution to the assignment plan—these reasons surface the underlying systematic problems in the project or variabilities that cannot be controlled e.g. weather. These systematic problems and e.g. weather problems are not typically discovered during the identification of the constraints at the initial stage, but now they serve to reveal problems that may be addressed.

Comparing with the traditional way of activity focused schedule, the constraint-based scheduling approach adopted in the IPS of the example embodiment provides an enhanced framework for pre-production constraint management. It allows for detecting and reducing schedule uncertainties, analyzing the key bottleneck constraints, and diminishing delays with pull-driven schedule control. In implementation, the IPS employs a series of task buffers implemented as databases to identify RI constraints and systematically resolve them so that each task can advance from one buffer to another, thus providing for a stable workflow. Eventually, in the final buffer, the constraints are fully resolved resulting in greater reliability in the work plan. Only when this condition is attained, the tasks can be scheduled for the weekly assignment plan.

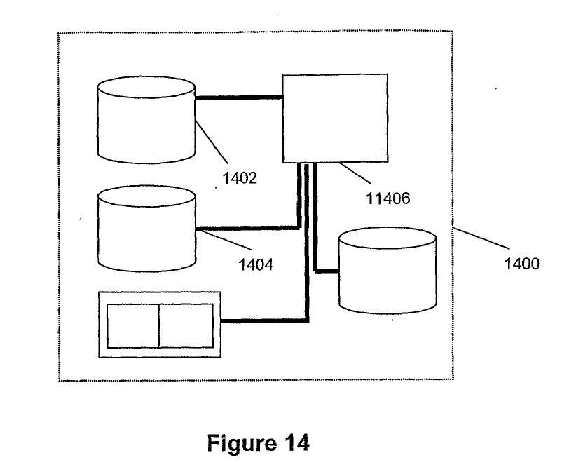

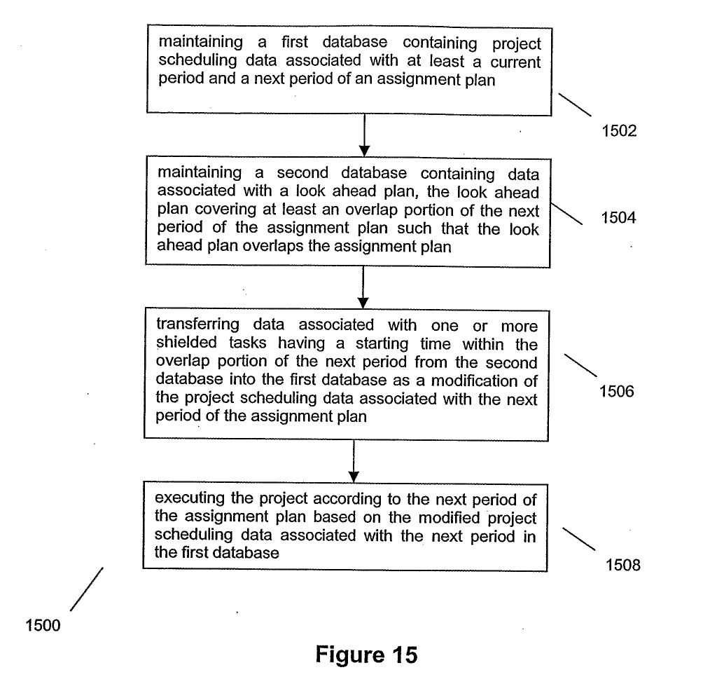

With reference to FIG. 14, schematic diagram of a purpose built system 1400 for constraint-based project scheduling in an example embodiment is shown. The system 1400 comprises a first database 1402 containing project scheduling data associated with at least the current period and the next period of the assignment plan. The system 1400 further comprises a second database 1404 containing data associated with the look ahead plan, and the look ahead plan covers at least an overlap portion of the next period of the assignment plan such that the look ahead plan overlaps the assignment plan. The system 1400 further comprises a processor unit 1406 coupled to the first and second databases 1402, 1404 for transferring data associated with one or more shielded tasks having a starting time within the overlap portion of the next period from the second database into the first database as a modification of the project scheduling data associated with the next period of the assignment plan.

The system 1400 may further comprise a third database 1408 containing data associated with the constraints, and the processor unit is coupled to the third database for updating status information of the constraints as a manipulation of the data in the third database.

FIG. 15 shows a flowchart 1500 illustrating a method of constraint-based project scheduling according to and example embodiment.

Step 1502 involves maintaining a first database containing project scheduling data associated with at least a current period and a next period of an assignment plan;

Step 1504 involves maintaining a second database containing data associated with a look ahead plan, the look ahead plan covering at least an overlap portion of the next period of the assignment plan such that the look ahead plan overlaps the assignment plan;

Step 1506 involves transferring data associated with one or more shielded tasks having a starting time within the overlap portion of the next period from the second database into the first database as a modification of the project scheduling data associated with the next period of the assignment plan; and

Step 1508 involves executing the project according to the next period of the assignment plan based on the modified project scheduling data associated with the next period in the first database.

Example embodiments of the present invention may have the following features and advantages.

Example embodiments of the present invention can enhance the Project Management function for project managers and project teams. Project managers and teams can gain a task perspective of the plan and be able to ‘get behind’ what was planned as all the necessary details are displayed and made readily available through a Graphical User Interface (GUI) available in the software of the example embodiments (e.g. the IPS GUI). A ‘To Do’/Watch list of constraints can also be generated through the Graphical User Interface available in the software. The project teams simply need to focus on the constraints. When the constraints are resolved, the associated tasks become “can do” and when the constraints are managed, the task is managed. Tracking parameters explain the status of the constraints. The project managers and teams are hence better informed of the status of the project. They can then better decide their actions instead of “fire-fighting” based on a disarrayed plan.

Also, by providing integrated constraint management, which uses tracking parameters to monitor the status of the constraints that have implications on the schedule, example embodiments of the present invention enable project managers and their team to be better informed of the progress of not just the task network but also the “hidden flows” of the project, and thus allows them to be able to take early remedial actions on the delayed “hidden flows”.

Using a series of task buffers to categorize and manage tasks based on their status and in conjunction with an advisory schedule provided by the APDM or ACPM to separate “can do” from “should do”, example embodiments can help project meetings become more organized and productive by enabling the project managers and their team to focus on required actions for each category. Example embodiments also allow for contingency actions by providing a workable backlog automatically controlled or influence by the advisory schedule for swapping of tasks to ensure stable workflow, which is not possible with conventional project planning.

Variations in project communication, the engineering process or any other project sub-process/systems remain obscure and detrimental to the project unless they are identified and corrected. In example embodiments of the present invention, these systemic variations are identified through plan variance analysis, which fosters continual improvement in project systems and delivery.

Furthermore, project meetings are improved because the project team members are now guided by the framework to focus on removing roadblocks instead of shifting blame. Ultimately, the main objectives of the project are accomplished.

Moreover, project teams may also analyse from Percent Plan Completion and Variance reports generated by the GUI of the example embodiments to prevent future occurrence of problems that lead to undesired project performance, and take performance to a higher level. In addition, by generating a Key Constraint report and a full Constraint Watch List Summary, a focused action plan can be determined and executed, resulting in even higher efficiency.

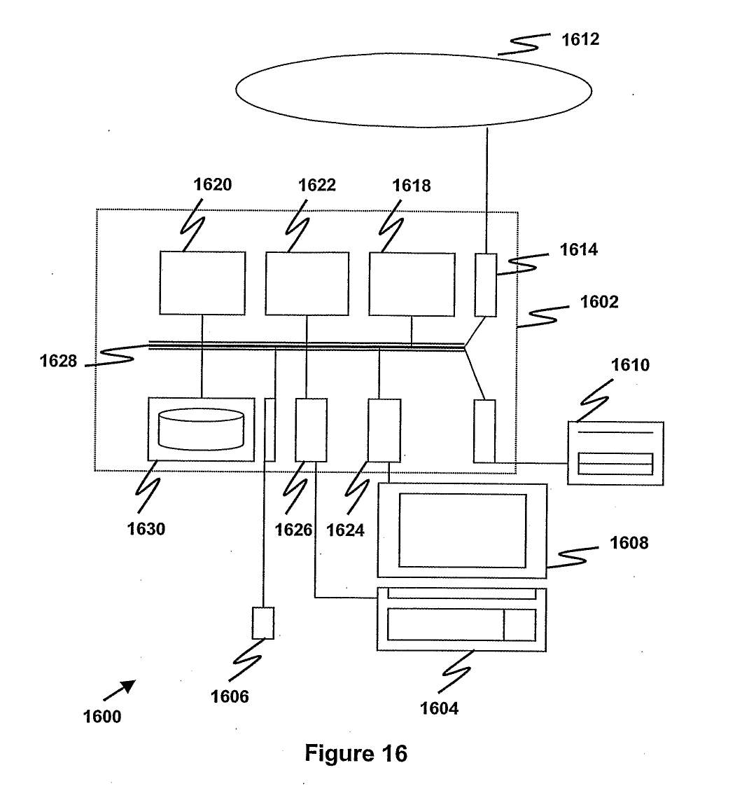

The methods, algorithms, and IPS of the example embodiment can also be implemented on a computer system 1600, schematically shown in FIG. 16. It may be implemented as software, such as a computer program being executed within the computer system 1600, and instructing the computer system 1600 to conduct the method of the example embodiment.

The computer system 1600 comprises a computer module 1602, input modules such as a keyboard 1604 and mouse 1606 and a plurality of output devices such as a display 1608, and printer 1610.

The computer module 1602 is connected to a computer network 1612 via a suitable transceiver device 1614, to enable access to e.g. the Internet or other network systems such as Local Area Network (LAN) or Wide Area Network (WAN).

The computer module 1602 in the example includes a processor 1618, a Random Access Memory (RAM) 1620 and a Read Only Memory (ROM) 1622. The computer module 1602 also includes a number of Input/Output (I/O) interfaces, for example I/O interface 1624 to the display 1608, and I/O interface 1626 to the keyboard 1604.

The components of the computer module 1602 typically communicate via an interconnected bus 1628 and in a manner known to the person skilled in the relevant art.

The application program is typically supplied to the user of the computer system 1600 encoded on a data storage medium such as a CD-ROM or flash memory carrier and read utilising a corresponding data storage medium drive of a data storage device 1630. The application program is read and controlled in its execution by the processor 1618. Intermediate storage of program data maybe accomplished using RAM 1620.

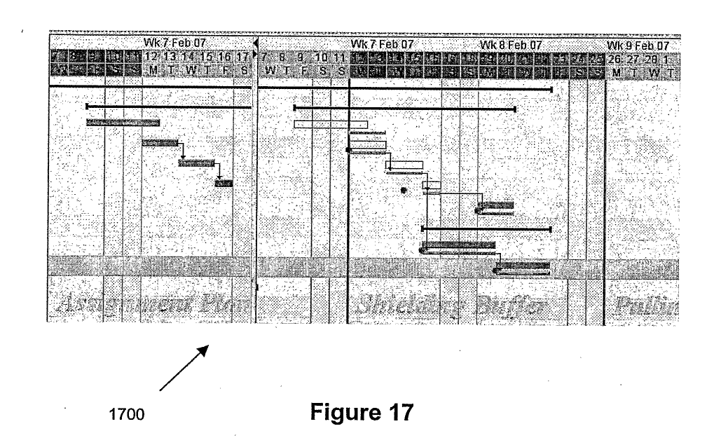

FIG. 17 shows a screen shot 1700 of a split screen GUI implemented in one example embodiment.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of constraint-based project scheduling comprising:
maintaining a first database containing project scheduling data associated with at least a current period and a next period of an assignment plan;
maintaining a second database containing data associated with a look ahead plan, the look ahead plan covering at least an overlap portion of the next period of the assignment plan such that the look ahead plan overlaps the assignment plan;
transferring data associated with one or more shielded tasks having a starting time within the overlap portion of the next period from the second database into the first database as a modification of the project scheduling data associated with the next period of the assignment plan; and
executing the project according to the next period of the assignment plan based on the modified project scheduling data associated with the next period in the first database.

2. The method as claimed in claim 1, further comprising displaying respective portions of the assignment plan and the look ahead plan based on the data contained in the first and second databases respectively and including the overlap portion of the next period.

3. The method as claimed in claim 2, further comprising generating an advisory schedule path based on processing the project scheduling data in the second database.

4. The method as claimed in claim 3, further comprising updating the advisory schedule path based on modifications of project scheduling data in the second database.

5. The method as claimed in claim 3, wherein the advisory schedule path is generated based on the Augmented Precedence Diagram Method (APDM) or the Augmented Critical Path Method (ACPM).

6. The method as claimed in claim 3, further comprising displaying the advisory schedule path on the displayed look ahead plan.

7. The method as claimed in claim 1, wherein the look ahead plan comprises a pulling period, and the method further comprises manipulating the project scheduling data associated with the pulling period based on analysis of constraints and the advisory schedule path.

8. The method as claimed in claim 7, further comprising maintaining a third database containing data associated with the constraints, and updating status information of the constraints as a manipulation of the data in the third database.

9. The method as claimed in claim 8, wherein the data associated with the constraints comprises a set of verification parameters for each constraint for tracking and managing a hidden flow associated with the project.

10. The method as claimed in claim 8, wherein only data associated with tasks shielded from uncertainties in the constraints associated with said respective tasks are available for transfer into the first database.

11. The method as claimed in claim 10, wherein data associated with tasks having uncertainties in the constraints associated with said respective tasks are not available for transfer into the first database, and data representing starting dates of said respective tasks in the look ahead plan is manipulated to be outside at least the overlap portion of the next period.

12. A system for constraint-based project scheduling comprising:
a first database containing project scheduling data associated with at least a current period and a next period of an assignment plan;
a second database containing data associated with a look ahead plan, the look ahead plan covering at least an overlap portion of the next period of the assignment plan such that the look ahead plan overlaps the assignment plan; and
a processor unit for transferring data associated with one or more shielded tasks having a starting time within the overlap portion of the next period from the second database into the first database as a modification of the project scheduling data associated with the next period of the assignment plan.

13. The system as claimed in claim 12, further comprising a display for displaying respective portions of the assignment plan and the look ahead plan based on the data contained in the first and second databases respectively and including the overlap portion of the next period.

14. The system as claimed in claim 13, wherein the processor unit generates an advisory schedule path based on processing the project scheduling data in the second database.

15. The system as claimed in claim 14, wherein the processor unit updates the advisory schedule path based on modifications of project scheduling data in the second database.

16. The system as claimed in claim 14, wherein the advisory schedule path is generated by the processor unit based on the Augmented Precedence Diagram Method (APDM) or the Augmented Critical Path Method (ACPM).

17. The system as claimed in claim 14, wherein the display further displays the advisory schedule path on the displayed look ahead plan.

18. The system as claimed claim 12, wherein the look ahead plan comprises a pulling period, and the processor unit is utilized to manipulate the project scheduling data associated with the pulling period based on analysis of constraints and the advisory schedule path.

19. The system as claimed in claim 18, further comprising a third database containing data associated with the constraints, and the data processor is utilized to update status information of the constraints as a manipulation of the data in the third database.

20. The system as claimed in claim 19, wherein the data associated with the constraints comprises a set of verification parameters for each constraint for tracking and managing a hidden flow associated with the project.

21. The system as claimed in claim 19, wherein only data associated with tasks shielded from uncertainties in the constraints associated with said respective tasks are available for transfer into the first database.

22. The system as claimed in claim 21, wherein data associated with tasks having uncertainties in the constraints associated with said respective tasks are not available for transfer into the first database, and data representing starting dates of said respective tasks in the look ahead plan is manipulated to be outside at least the overlap portion of the next period.

23. A system of constraint-based project scheduling comprising:
means for maintaining a first database containing project scheduling data associated with at least a current period and a next period of an assignment plan;
means for maintaining a second database containing data associated with a look ahead plan, the look ahead plan covering at least an overlap portion of the next period of the assignment plan such that the look ahead plan overlaps the assignment plan;
means for transferring data associated with one or more shielded tasks having a starting time within the overlap portion of the next period from the second database into the first database as a modification of the project scheduling data associated with the next period of the assignment plan.

24. A data storage medium containing computer readable code means for instructing a computer system to execute a method for constraint-based project scheduling comprising:
maintaining a first database containing project scheduling data associated with at least a current period and a next period of an assignment plan;
maintaining a second database containing data associated with a look ahead plan, the look ahead plan covering at least an overlap portion of the next period of the assignment plan such that the look ahead plan overlaps the assignment plan; and
transferring data associated with one or more shielded tasks having a starting time within the overlap portion of the next period from the second database into the first database as a modification of the project scheduling data associated with the next period of the assignment plan.

25. The method as claimed in claim 1, wherein said look ahead plan further comprises at least one task buffer.

26. The method of claim 25, wherein the at least one task buffer is selected from a group consisting of a shielding buffer, a pulling buffer and a screening buffer.

27. The method as claimed in claim 3, wherein the advisory schedule path is calculated and updated based on at least one parameter selected from a group consisting of a task precedence relationship, a task start date condition, a time of a prerequisite constraint, a states of a verification parameter, a buffer policy, and a task status.

28. The system as claimed in claim 12, wherein said look ahead plan further comprises at least one task buffer.

29. The system of claim 28, wherein the at least one task buffer is selected from a group consisting of a shielding buffer, a pulling buffer and a screening buffer.

30. The system as claimed in claim 15, wherein the advisory schedule path is calculated and updated based on at least one parameter selected from a group consisting of a task precedence relationship, a task start date condition, a time of a prerequisite constraint, a states of a verification parameter, a buffer policy, and a task status.
